(19) United States
(12) Patent Application Publication
(10) Pub. No.: US 2014/0113166 A1
(43) Pub. Date: Apr. 24, 2014

(54) SAFETY DEVICE FOR ARRANGEMENT IN A BATTERY CELL OF A LITHIUM-ION BATTERY, LITHIUM-ION BATTERY CELL WITH SAFETY DEVICE

(71) Applicants: Samsung SDI Co., Ltd., Yongin-si (KR); Robert Bosch GmbH, Stuttgart (DE)

(72) Inventors: Jens Schneider, Leonberg (DE); Anne Heubner, Stuttgart (DE); Holger Reinshagen, Bamberg (DE)

(73) Assignees: Samsung SDI Co., Ltd., Yongin-si (KR); Robert Bosch GmbH, Stuttgart (DE)

(21) Appl. No.: 14/057,323

(22) Filed: Oct. 18, 2013

(30) Foreign Application Priority Data
Oct. 19, 2012 (DE) 10 2012 219 082.1

(51) Int. Cl. H01M 10/6571

(52) U.S. Cl. CPC H01M 10/5083
USPC 429/62; 429/120; 429/90; 219/494

(57) ABSTRACT

A safety device for arrangement in a battery cell of a lithium-ion battery includes at least one metallic conductor configured in a planar form, in particular a metal plate or a metal foil. The conductor includes an insulating layer applied thereon and a terminal contact configured for the electrical connection to a terminal of the battery cell. The conductor has at least one heating resistor with a first contact and a second contact arranged on the insulating layer so as to enable an electric current to be passed through the heating resistor by way of the contacts. A battery module with a control device includes at least one lithium-ion battery cell with the safety device.

This application claims priority under 35 U.S.C. §119 to patent application no. DE 10 2012 219 082.1, filed on Oct. 19, 2012 in Germany, the disclosure of which is incorporated herein by reference in its entirety.

### BACKGROUND

The disclosure relates to a safety device for arrangement in a battery cell of a lithium-ion battery, comprising at least one metallic conductor of a planar form, in particular a metal plate or a metal foil, to which an insulating layer has been applied and which has a terminal contact for the electrical connection to a terminal of the battery cell.

The disclosure also relates to a lithium-ion battery cell with a safety device, which comprises at least one metallic conductor of a planar form, in particular a metal plate or a metal foil, to which an electrical insulating layer has been applied, the conductor being connected to a terminal of the battery cell by way of a terminal contact.

In addition, the disclosure relates to a battery module with one or more battery cells and a control device.

Lithium-ion batteries (also known as rechargeable lithium-ion batteries) have to meet various requirements, in particular depending on their area of use. Particularly diverse requirements are imposed on lithium-ion batteries that are used in electric or hybrid vehicles. Two significant requirements in this respect concern on the one hand the safety of the lithium-ion battery cells and on the other hand the thermal management of the lithium-ion battery cells.

With respect to the safety of lithium-ion batteries, various safety devices are known. In particular, the prior art discloses aforementioned safety devices by the name nail safety devices. Such a nail safety device may comprise a copper foil, which is arranged between the anode of a lithium-ion battery cell and the housing of the lithium-ion battery cell and is connected to the anode in an electrically conducting manner. In addition, further configurations of such a nail safety device are known. For instance, EP 2 355 202 A1 discloses a nail safety device which comprises two copper plates insulated from one another, the first copper plate being electrically connected to the first electrode of the battery cell and the second copper plate being electrically connected to the second electrode of the battery cell. A nail safety device ensures in the event of mechanical damage to a battery cell of a lithium-ion battery, for example when the battery cell housing is punctured by a nail, that a short-circuit current forming spreads out over the copper foil or the copper plates, the large area and the low electrical resistance of the copper having the effect that there is no local overheating inside the battery cell. This counteracts a risk of fire posed by the battery cell.

Furthermore, the prior art discloses various devices with respect to the thermal management of a lithium-ion battery. Thermal management is required in particular in the case of rechargeable lithium-ion batteries that are used in electric or hybrid motor vehicles for the vehicle to operate efficiently at low and high temperatures. Known in particular are devices for the indirect temperature control of battery systems by way of external thermal management, for example by means of air cooling or a cooling plate, the cooling plate in turn being air-cooled or fluid-cooled. In order to operate lithium-ion batteries efficiently at low temperatures, it is required to heat the battery cells of the rechargeable lithium-ion battery. For the direct heating of battery cells, the prior art discloses resistance heating systems, which are arranged either inside a battery cell or on the housing of the battery cell.

Since ever lighter lithium-ion batteries or lithium-ion batteries with a high energy density are sought in automobile construction in particular, and there is in addition a demand for the low-cost manufacture of lithium-ion batteries that are suitable for use in electric or hybrid motor vehicles, it is an object of the present disclosure to provide at low cost and with reduced weight a lithium-ion battery that has a safety device mentioned at the beginning and a cell heating system.

### SUMMARY

To achieve the object, a safety device for arrangement in a battery cell of a lithium-ion battery is proposed, comprising at least one metallic conductor of a planar form, in particular a metal plate or a metal foil, to which an insulating layer has been applied and which has a terminal contact for the electrical connection to a terminal of the battery cell, the conductor having at least one heating resistor with a first and a second contact arranged on the insulating layer, it being possible for an electric current to be passed through the heating resistor by way of the contacts. The at least one heating resistor is advantageously connected to the metallic conductor in a heat-conducting manner. In particular, it is provided that the heating resistor is arranged on the metallic conductor in such a way that the Joulean heat produced by the heating resistor flowed through by current significantly increases the thermal energy of the metal plate. The metallic conductor is preferably made of copper, but other metals that are good conductors, such as for example silver, can also be used. The heating resistor may consist in particular of a heating conductor alloy. The resistance value of the heating resistor advantageously has a defined temperature dependence, so that the temperature inside the battery cell can be determined, or can at least be approximately determined, by ascertaining the resistance value of the heating resistor.

The disclosure is based on the realization that applying a heating resistor to a metal plate or foil of a nail safety device can produce a combined component that is able to perform both functions as a safety device and functions as a cell heating system. The metallic conductor of the safety device, which in the event of a short-circuit as a result of the puncturing of a battery cell of a lithium-ion battery by means of an object discharges the short-circuit current, serves in this case during normal operation of the battery cell in particular as a support and heat conductor for the at least one heating resistor or a resistance structure applied as a heating resistor. The function as a cell heating system that is additionally provided by the safety device according to the disclosure in comparison with a conventional nail safety device in this case advantageously does not impair the primary function as a safety device. The proposed combined component comprising the nail safety device and the cell heating system can advantageously be manufactured at lower cost than the respectively separate components and is reduced in weight in comparison with them.

According to a preferred configuration of the disclosure, it is provided that the first contact of the heating resistor is the terminal contact. The first contact therefore corresponds to the contact by way of which the metallic conductor of the safety device is connected to the terminal of the battery cell into which the safety device is fitted. The terminal contact in this case preferably corresponds to the anode contact, i.e. in the case of a safety device fitted into a battery cell the first contact of the heating resistor is electrically connected to the anode of the battery cell. Use of the already existing terminal contact of the safety device for the heating resistor advantageously obviates the need for an electrical connection or an outgoing conductor. As a result, a further reduction in weight and cost can be advantageously achieved.

According to a further advantageous configurational variant of the present disclosure, the conductor of the safety device has at least one temperature sensor arranged on the insulating layer. This temperature sensor can advantageously be used at least by the battery management system of a lithium-ion battery for determining the battery cell temperature. As a result of the good thermal conductivity of the metallic conductor, the cell temperature can be determined particularly well. According to an advantageous aspect of the present disclosure, a current is passed through the at least one heating resistor in dependence on the measured temperature values sensed by the temperature sensor. The temperature sensor can consequently be used as a component part of a controller for the safety device to be used according to the disclosure as a cell heating system. Preferably provided as the temperature sensor is an NTC component (NTC: Negative Temperature Coefficient). The temperature sensor should be designed in particular to operate with great accuracy in a temperature range from −40° C. to +120° C.

According to a preferred configuration of the disclosure, it is provided that the heating resistor is produced by a resistance structure or a resistance heater structure that has been applied to the insulating layer of the metallic conductor. The insulating layer of the metallic conductor may in particular be an insulating varnish. Such insulating varnishes are also used for example for the insulation of armature core assemblies used in electric motors. In particular, it is provided according to the disclosure that the resistance heater structure has been applied by printing or laminating onto the insulating layer of the conductor. According to an advantageous configuration of the disclosure, the heating resistor or the resistance heater structure has been applied to the insulating layer of the metallic conductor by means of screen-printing processes. The resistance value of the heating resistor may in this case be advantageously set by using cermet pastes with variable proportions of metal and ceramic. A further advantageous configuration provides that a temperature probe or a temperature sensor has been applied to the insulating layer of the metallic conductor as a discrete NTC component or as a printed NTC layer. According to an advantageous configurational variant of the disclosure, the heating resistor has been laminated onto the insulating layer of the metallic conductor, a prefabricated film assembly comprising thin films of plastic, preferably polypropylene films, preferably being laminated onto the insulating layer of the metallic conductor into which the resistance structure of the heating resistor has been embedded. According to a further advantageous configuration, furthermore, a temperature probe is integrated in the film laminate. The film laminate is preferably connected to the metallic conductor with a material bond by adhesive bonding. Preferably, the heating resistor applied to the metallic conductor and the possibly additionally applied temperature sensor are protected by a further film layer, in particular protected from the battery medium. To stabilize and improve the ease of handling the arrangement comprising the metallic conductor with the applied heating resistor and the temperature sensor, applied according to an advantageous configuration, and also possibly the protective layer surrounding the heating resistor and the temperature sensor, this arrangement is enclosed by a frame, this frame preferably being formed by one or more polypropylene films.

To achieve the object mentioned at the beginning, the present disclosure also proposes a lithium-ion battery cell with a safety device, which comprises at least one metallic conductor of a planar form, in particular a metal plate or a metal foil, to which an electrical insulating layer has been applied, the conductor being connected to a terminal of the battery cell by way of a terminal contact and having at least one heating resistor with a first and a second contact arranged on the insulating layer, the first contact being connected to a terminal of the battery cell having a first polarity and the second contact being connected via at least one switching element to a terminal of the battery cell or of a further battery cell having a second polarity.

It is provided according to the disclosure that the safety device of the lithium-ion battery cell according to the disclosure in this case advantageously has the aforementioned features of the safety device according to the disclosure individually or in combination. In particular, it is provided that the first contact of the heating resistor is the terminal contact, the terminal contact preferably being the anode contact, the first contact of the heating resistor therefore being connected to the anode of the battery cell. The switching element via which the second contact of the heating resistor is connected to a terminal of opposite polarity, preferably the cathode, of the same battery cell or else of another battery cell does not have to be integrated in the battery cell according to the disclosure. The switching element is preferably a component part of a battery management system that monitors the cell function. By means of the switching element, which is preferably configured as a switch, the current flow through the heating resistor can be advantageously controlled, preferably by a battery management system. With the switching element open, no current flows through the heating resistor; with the switching element closed, a current flows through the heating resistor. If a current flows through the heating resistor, the latter heats up, i.e. Joulean heat is produced and is given off to the metallic conductor. As a result of the thermal conductivity of the metallic conductor, the latter likewise heats up and gives off the thermal energy to the battery cell. In this way, the safety device according to the disclosure in the lithium-ion battery cell is operated or used as a cell heating system. According to a further safety function that is provided by the disclosure, the battery cell according to the disclosure is discharged when, with the switching element closed, the first contact of the heating resistor is connected to one terminal, for example the anode, of the battery cell and the second contact of the heating resistor is connected to the further terminal, for example the cathode of the battery cell. Such a desired discharge is of importance in particular in the case of lithium-ion battery cells used in vehicles after a vehicle crash. A discharged lithium-ion battery cell poses lower risks, in particular during the salvaging of the vehicle involved in an accident, since the risk of electric shocks or the risk of what is known as thermal runaway is reduced. According to a further advantageous aspect of the disclosure, the at least one switching element is therefore closed in the event of an accident, preferably initiated by a control device, preferably using crash sensors integrated in a vehicle, such as for example acceleration sensors.

According to a further advantageous aspect of the disclosure, an at least approximate determination of the cell temperature is provided as a further function by using the safety device according to the disclosure with the heating resistor applied to the metallic conductor. For this purpose, the heating resistor is of a temperature-dependent form, i.e. the resistance value of the heating resistor changes in a defined way in dependence on the temperature. A determination of the resistance value consequently also allows the cell temperature to be determined. The lithium-ion battery cell according to the disclosure advantageously has means for determining the resistance value of the heating resistor and/or the lithium-ion battery cell according to the disclosure is designed in such a way that a determination of the resistance value of the heating resistor is possible from the outside, for example by using the battery management system.

According to a further advantageous configuration of the lithium-ion battery cell according to the disclosure, the metallic conductor has at least one temperature sensor arranged on the insulating layer. As described in conjunction with the safety device according to the disclosure, this sensor may be applied to the metallic conductor. The temperature sensor can in this case advantageously be used to determine the cell temperature of the lithium-ion battery cell, the at least one switching element being controllable according to the disclosure with allowance for the determined temperature or corresponding measured temperature values, in order in this way to produce a controlled or regulated cell heating system.

To achieve the object mentioned at the beginning, furthermore, a battery module with one or more battery cells and a control device is proposed, characterized by at least one lithium-ion battery cell according to the disclosure. The control device is in this case advantageously the battery management system of the battery module or at least a component part of the battery management system. The control device is advantageously designed to sense in each case the resistance value of the at least one heating resistor of the at least one lithium-ion battery cell. This may take place according to the disclosure by indirect or direct resistance measurement. According to a further advantageous configuration of the disclosure, the control device is in each case connected to the at least one temperature sensor of the at least one lithium-ion battery cell, the control device being designed to determine at least approximately by means of the temperature sensor in each case the cell temperature of the respective lithium-ion battery cell. The cell temperature ascertained is in this case used for activating the at least one switching element, via which a current can be passed through the respective heating resistor of a battery cell. In this way, a controlled or regulated cell heating system is advantageously produced. According to a particularly preferred configuration of the disclosure, the control device is designed to control in each case the at least one switching element in relation to at least one lithium-ion battery cell, in particular in such a way that the respective heating resistor is used for heating up the lithium-ion battery cell, for determining the cell temperature of the lithium-ion battery cell and/or for discharging the lithium-ion battery cell.

### BRIEF DESCRIPTION OF THE DRAWINGS

Further advantageous details, features and configurational details of the disclosure are explained in more detail in connection with the exemplary embodiments that are represented in the figures, in which:

FIG. 1 shows an exemplary embodiment of a safety device according to the disclosure in a schematic representation;

FIG. 2 shows an exemplary embodiment of a lithium-ion battery cell according to the disclosure in a schematic representation;

FIG. 3 shows a connection diagram of an exemplary embodiment of a lithium-ion battery cell according to the disclosure;

FIG. 4 shows a connection diagram of a further exemplary embodiment of a lithium-ion battery cell according to the disclosure;

FIG. 5 shows a connection diagram of a further exemplary embodiment of a lithium-ion battery cell according to the disclosure;

FIG. 6 shows a connection diagram of a further exemplary embodiment of a lithium-ion battery cell according to the disclosure;

FIG. 7 shows a connection diagram of a further exemplary embodiment of a lithium-ion battery cell according to the disclosure;

FIG. 8 shows a connection diagram of an exemplary embodiment of a battery module according to the disclosure;

FIG. 9 shows a connection diagram of a further exemplary embodiment of a battery module according to the disclosure; and

FIG. 10 shows a connection diagram of a further exemplary embodiment of a battery module according to the disclosure.

### DETAILED DESCRIPTION

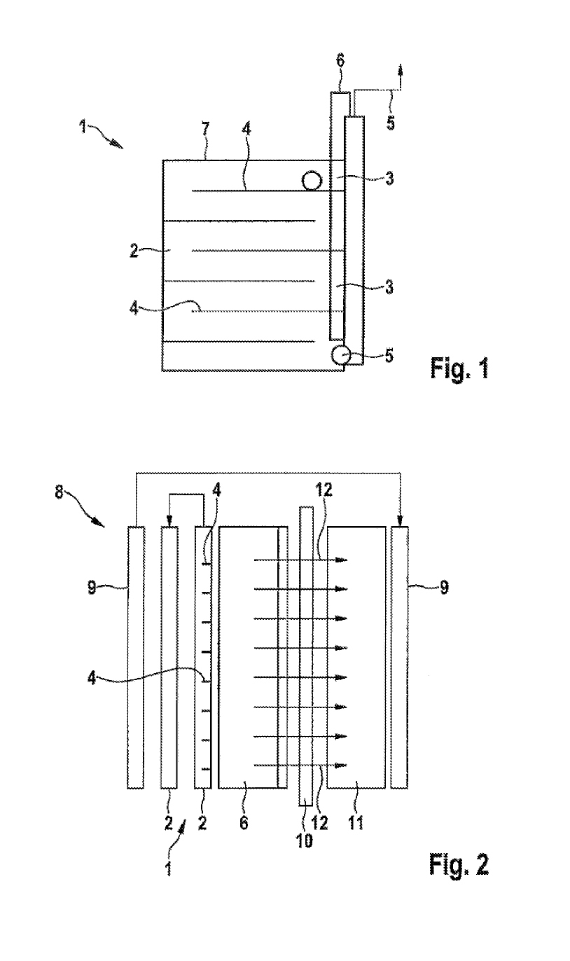

Represented in FIG. 1 is a safety device 1 according to the disclosure for arrangement in a battery cell of a lithium-ion battery that can be used not only as what is known as a nail safety device but also as a cell heating system and for discharging a battery cell in a lithium-ion battery cell. The safety device 1 in the present case comprises a metallic conductor 2 of a planar form. This metallic conductor 2 is a copper foil a few μm thick, to which an insulating varnish (not explicitly represented in FIG. 1) has been applied as an insulating layer. The insulating layer thereby insulates the copper foil 2 electrically with respect to the battery medium. The copper foil 2 has a terminal contact 3, by way of which the copper foil 2 can be connected to the anode 6 of a lithium-ion battery cell. A heating resistor 4 has been applied as a resistance structure to the insulating layer of the copper foil 2 by means of screen-printing processes (schematically represented in FIG. 1 by the lines with the reference numeral 4). Furthermore, a temperature sensor not explicitly represented in FIG. 1 has been applied as a printed NTC layer to the insulating varnish of the copper foil 2. The resistance structure 4 has a first contact 3, which is identical to the terminal contact 3 of the copper foil 2. Furthermore, the heating resistor has a second contact 5, by way of which the heating resistor 4 can be electrically connected to the cathode of a battery cell via a switching element that is not represented in FIG. 1 and is controlled by a battery management system, so that, when there is a corresponding electrical connection, a current can be passed through the heating resistor 4. The copper foil 2 is surrounded by a frame structure 7 of polypropylene for stabilization.

Represented in FIG. 2 in a schematic representation is a lithium-ion battery cell 8 with a safety device 1 according to the disclosure. The lithium-ion battery cell 8 is enclosed by a housing 9. The lithium-ion battery cell 8 has an anode 6, a cathode 11, separated from the anode 6 by a separator 10, and a safety device 1 arranged between the housing 9 and the anode 6. The safety device 1 in the present case comprises two copper plates 2, the copper plates 2 being connected to the anode 6 (not explicitly represented in FIG. 2). The arrows 12 represented in FIG. 2 symbolize the flow of lithium ions from the anode to the cathode. A resistance structure has been laminated onto one of the copper plates as a heating resistor 4 (symbolically represented in FIG. 2 by the lines with the reference numeral 4) and connected to the copper plate with a material bond by adhesive bonding. The heating resistor 4 is connected to the anode 6 of the lithium-ion battery cell 8 by way of an electrical contact. The heating resistor 4 is additionally connected to the cathode 11 of the battery cell 8 via a switching element that is not explicitly represented in FIG. 2, so that, with the switching element closed, a current flows through the heating resistor 4, the current flow having the effect of heating up the resistor 4. As a result of a heat-conducting connection between the copper plate 2 and the heating resistor 4, the heating resistor 4 also heats up the copper plate 2, whereby the safety device 1 is used according to the disclosure to produce a cell heating system.

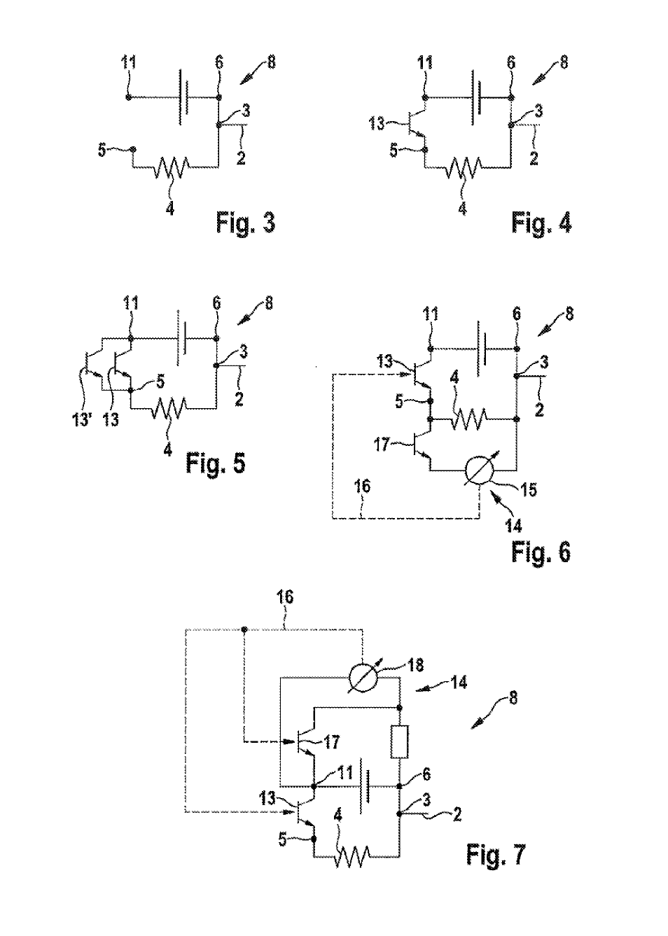

FIG. 3 shows a connection diagram of a lithium-ion battery cell 8 according to the disclosure. By way of a common contact 3, a metallic conductor 2 (symbolized by the line with the reference numeral 2 leading away from the contact 3) and a heating resistor 4 are connected to the anode 6 of a lithium-ion battery cell. The heating resistor 4 also has a second contact 5.

In the connection diagram represented in FIG. 4, a switching element 13 is arranged between the second contact 5 of the heating resistor 4 and the cathode 11. Via this switching element 13, the heating resistor 4 is connected to the cathode 11 of the lithium-ion battery cell. With the switching element 13 closed, a current flows through the heating resistor, whereby the latter heats up. The lithium-ion battery cell is thereby discharged. With the switching element 13 open, no current flows through the heating resistor 4. According to the disclosure, a number of switching elements 13 may be connected in parallel, in order to produce different functions by the switching operations, for example an enforced discharge initiated by a cell supervision circuit after a vehicle crash and a temperature-dependent type of connection to use the heating resistor 4 applied to the metallic conductor 2 as a cell heating system. FIG. 5 shows an exemplary embodiment in which a further switching element 13′ is connected in parallel with the switching element 13. In particular, however, it is also provided that the switching element 13 is a digital switch, which can be variously activated, in particular by a battery management system.

In the case of the connection diagrams of lithium-ion battery cells 8 according to the disclosure that are represented in FIG. 6 and FIG. 7, in each case a temperature-dependent heating resistor 4 is used, the lithium-ion battery cell 8 in each case having connection possibilities for means 14 for determining the resistance value or having means 14 for determining the resistance value. As a result of the temperature dependence of the resistance value of the heating resistor 4, the temperature inside the lithium-ion battery cell 8 can be determined, or at least approximately determined, on the basis of the resistance value ascertained, a deviation of the temperature ascertained from the actual cell temperature by a few ° C. being tolerable in the case of an approximate determination. In the exemplary embodiment of the disclosure that is represented in FIG. 6, a resistance measuring device 15 is used for the direct resistance measurement. The switch 17 is in this case optional. If the cell temperature is constantly monitored, it is possible to dispense with the use of the switch 17. As shown in FIG. 7, the resistance value of the heating resistor 4 may, however, also be ascertained indirectly by determining the voltage drop across the heating resistor 4 flowed through by current. For this purpose, a voltmeter 18 is used. The arrows 16 represented by dashed lines in FIG. 6 and FIG. 7 symbolize that an external control device in particular, such as a battery management system or a cell supervision circuit, can access the means 14 for resistance measurement. In particular, it is provided that the resistance values ascertained are transmitted to external control devices, in particular in order to be able to control the switching elements 13 in dependence on the temperature ascertained inside the lithium-ion battery cell 8.

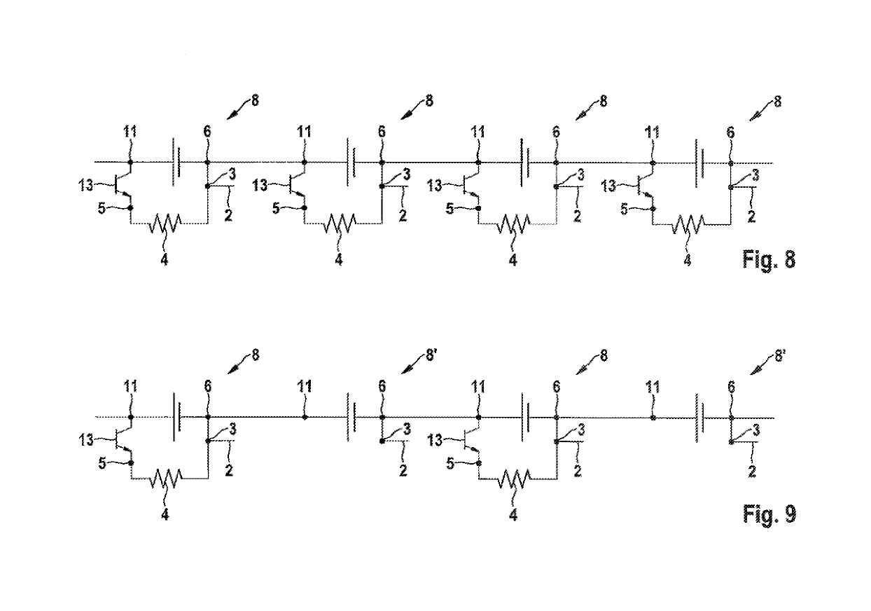

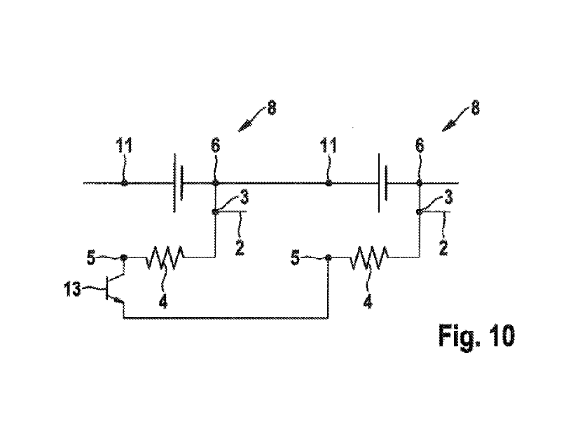

Represented in FIG. 8 to FIG. 10 are connection diagrams of exemplary embodiments of battery modules according to the disclosure. The battery management system of the respective battery module is in this case not explicitly represented. In FIG. 8, lithium-ion battery cells 8 according to the disclosure are connected in series to form a battery module according to the disclosure. Represented in FIG. 9 is a battery module in which every second lithium-ion battery cell 8 has a safety device according to the disclosure. The other lithium-ion battery cells 8′ are equipped with a conventional nail safety device. In FIG. 10, a battery module has two lithium-ion battery cells 8 according to the disclosure. Here, a heating resistor 4 of a lithium-ion battery cell 8 is respectively connected by way of the first contact 3 to a terminal of the lithium-ion battery cell 8, having a first polarity, and by way of the second contact 5 via a switching element 13 to a terminal of a further lithium-ion battery cell 8, having a second polarity.

The exemplary embodiments represented in the figures and explained in connection with them serve for explaining the disclosure and do not have any restrictive effect on it.

What is claimed is:

1. A safety device for arrangement in a battery cell of a lithium-ion battery, comprising:
at least one metallic conductor of a planar form to which an insulating layer has been applied and which has a terminal contact configured for electrical connection to a terminal of the battery cell,
wherein the conductor has at least one heating resistor with a first contact and a second contact arranged on the insulating layer, the first and second contacts being configured to enable an electric current to be passed through the heating resistor.

2. The safety device according to claim 1, wherein the first contact of the heating resistor is the terminal contact.

3. The safety device according to claim 1, wherein the conductor has at least one temperature sensor arranged on the insulating layer.

4. A lithium-ion battery cell, comprising:
a safety device including:
at least one metallic conductor of a planar form to which an electrical insulating layer has been applied, the conductor being connected to a terminal of the battery cell by way of a terminal contact,
wherein the conductor has at least one heating resistor with a first contact and a second contact arranged on the insulating layer, the first contact being connected to a terminal of the battery cell having a first polarity and the second contact being connected via at least one switching element to a terminal of the battery cell or of a further battery cell having a second polarity.

5. The lithium-ion battery cell according to claim 4, wherein the conductor has at least one temperature sensor arranged on the insulating layer.

6. The lithium-ion battery cell according to claim 4, wherein the first contact of the heating resistor is the terminal contact

7. A battery module, comprising:
a control device; and
one or more battery cells, the one or more battery cells including at least one lithium-ion battery cell including a safety device, the safety device including:
at least one metallic conductor of a planar form to which an electrical insulating layer has been applied, the conductor being connected to a terminal of the battery cell by way of a terminal contact,
wherein the conductor has at least one heating resistor with a first contact and a second contact arranged on the insulating layer, the first contact being connected to a terminal of the battery cell having a first polarity and the second contact being connected via at least one switching element to a terminal of the battery cell or of a further battery cell having a second polarity.

8. The battery module according to claim 7, wherein the control device is configured to sense in each case the resistance value of the at least one heating resistor of the at least one lithium-ion battery cell.

9. The battery module according to claim 7, wherein the conductor has at least one temperature sensor arranged on the insulating layer, and wherein the control device is in each case connected to the at least one temperature sensor of the at least one lithium-ion battery cell, the control device being configured to determine via the temperature sensor in each case the cell temperature of the lithium-ion battery cell.

10. The battery module according to claim 7, wherein the control device is configured to control the at least one switching element of the at least one lithium-ion battery cell in such a way that the respective heating resistor is configured to be used for one or more of (i) heating up the lithium-ion battery cell, (ii) determining the cell temperature of the lithium-ion battery cell, and (iii) discharging the lithium-ion battery cell.

11. The safety device according to claim 1, wherein the at least one metallic conductor is configured as a metal plate or a metal foil.

12. The lithium-ion battery cell according to claim 4, wherein the at least one metallic conductor is configured as a metal plate or a metal foil.
